(19) United States
(12) Patent Application Publication
(10) Pub. No.: US 2025/0353866 A1
(43) Pub. Date: Nov. 20, 2025

(54) METHOD FOR PREPARING METAL ORGANIC FRAMEWORK

(71) Applicants: Hyundai Motor Company, Seoul (KR); Kia Corporation, Seoul (KR); POSTECH Research and Business Development Foundation, Pohang-si (KR)

(72) Inventors: Seung Joon LEE, Hwaseong-Si (KR); Sunah PARK, Hwaseong-Si (KR); Jaekyung YI, Hwaseong-Si (KR)

(21) Appl. No.: 19/210,604

(22) Filed: May 16, 2025

(30) Foreign Application Priority Data
May 20, 2024 (KR) 10-2024-0065371
Dec. 9, 2024 (KR) 10-2024-0181920

(51) Int. Cl. C07F 3/06; B01J 19/10

(52) U.S. Cl. CPC C07F 3/06; B01J 19/10

(57) ABSTRACT

A metal organic framework may be prepared using acoustic cavitation. The method includes preparing a precursor solution including a metal precursor and an organic ligand; emitting an ultrasonic wave to the precursor solution; centrifuging the precursor solution to obtain a precipitate; and washing and drying the precipitate. A solvent of the precursor solution may have a boiling point of 170° C. or lower.

### CROSS-REFERENCE TO RELATED APPLICATION

This application claims the benefit of priority to Korean Patent Application No. 10-2024-9965371, filed in the Korean Intellectual Property Office on May 20, 2024, and Korean Patent Application No. 10-2024-0181920, filed in the Korean Intellectual Property Office on Dec. 9, 2024, the entire contents of which are incorporated herein by reference.

### TECHNICAL FIELD

The present disclosure relates to a method for preparing a metal organic framework, said method being capable of efficiently preparing the metal organic framework in a short time under a mild condition using ultrasonic waves.

### BACKGROUND

A metal organic framework is a material in which metal ions or clusters of metal ions are connected to each other via organic ligands to form a framework having a certain structure with pores formed inside the structure. The above metal organic framework has a property of being capable of adsorbing fine molecules and/or storing a material such as hydrogen. Due to this property, metal organic frameworks have been studied as new materials that may be used in various fields.

The synthesis of the metal organic framework may be performed by various methods, such as a solvothermal synthesis method. The solvothermal synthesis method uses thermal energy as an energy source for self-assembly between a glass ligand and a metal precursor. In this method, crystallization is induced by dissolving the organic ligand and the metal precursor in a solvent and then heating the solution. The reaction(s) in the solvothermal synthesis method is/are performed under high temperature and pressure in a closed container, which may take a very long time to complete the reaction. A uniform thermal condition of the reaction system should be established for crystal grain generation and growth of the metal organic framework. The energy supply stability to the system should be maintained for a very long time until the reaction is completed. Since pore structural stability of the structure is secured via self-assembly of the metal precursor solvent and the organic ligand solvent, the concentration of each of the metal precursor and the organic ligand in the solvent should be kept very low, which means that the amount of the solvent required for the reaction is very great.

Another problem with the use of the solvothermal synthesis method is that a modulator is required. The coordination structure of the ligand and the metal in the metal organic framework is formed via a self-assembly phenomenon. However, for crystal structure generation and growth, a reversible change in the coordination environment between the metal site and the organic ligand site is required. In order to induce the generation and growth of crystal grains, it is common to utilize triethylamine (TEA) for deprotonation of ligands as the modulator to establish reversibility of metal organic chelating or to utilize a modulator with a carboxylate anion such as sodium carboxylate to expand reversibility of ligand carboxylate. However, the above condition of introduction of the modulator may act as a variable factor in the crystal growth of the metal organic framework. Therefore, due to the above problems, the solvothermal synthesis method may not be suitable for the synthesis of the metal organic framework, particularly for mass synthesis thereof.

Methods of synthesizing the metal organic framework using ultrasonic waves may solve the problem of the solvothermal synthesis method. If a fluid is exposed to ultrasonic waves, the fluid pressure in a local area temporarily decreases below the vapor pressure due to the high-speed motion condition of the fluid molecule. This creates microbubbles in the fluid, which is called acoustic cavitation. The cavity formed in the fluid undergoes three stages of nuclear growth, growth and collapse. The critical size of the cavity under frequency conditions of about 20 kHz is about 170μ in diameter. When the cavity grows beyond the critical size, the cavity in the sound wave system cannot efficiently absorb energy, so that the size is not maintained and the cavity collapse occurs, and the energy is released. The cavity collapse at the local site precedes heat transfer, resulting in the formation of local hot spots in the fluid. In general, if a solid is present in a fluid, millions of microcavity collapses occur on the solid surface, and due to the asymmetric environment between the solid surface and the fluid system, an airflow phenomenon in which energy flows in the solid surface occurs. Utilizing such an energy flow allows a metal organic framework to be synthesized. However, a high ultrasonic output is required for ultrasonic wave synthesis and, as in the solvothermal synthesis method, the use of the modulator is required. These limiting reaction conditions serve as an obstacle to the mass synthesis of metal organic frameworks by ultrasonic wave synthesis methods.

Accordingly, there is a need for a method for preparing a metal organic framework capable of overcoming the limitations in the solvothermal synthesis method and the ultrasonic wave synthesis method to enable the mass synthesis of the metal organic framework even under a relatively mild condition.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a preparing a metal organic framework. A method for preparing a metal organic framework may comprise: preparing a precursor solution comprising a metal precursor and an organic ligand; emitting an ultrasonic wave to the precursor solution; centrifuging the precursor solution; removing a supernatant from the centrifuged precursor solution to obtain a precipitate; and washing and drying the precipitate, wherein a solvent of the precursor solution has a boiling point in a range of 35° C. to 170° C.

Also, or alternatively, a method for preparing a metal organic framework may comprise: preparing a precursor solution comprising: a metal precursor; an organic ligand; and a solvent; emitting, via a sonication bath, an ultrasonic wave to the precursor solution; centrifuging the precursor solution; removing a supernatant from the centrifuged precursor solution to obtain a precipitate; and washing and drying the precipitate.

Also, or alternatively, a method for preparing a metal organic framework, the method comprising: preparing a precursor solution comprising: a metal precursor; an organic ligand; and a solvent selected from a group consisting of water, dimethylformamide, methanol, and ethanol; emitting, via a sonication bath, an ultrasonic wave to the precursor solution; centrifuging the precursor solution; and removing a supernatant from the centrifuged precursor solution to obtain a precipitate.

A metal organic framework may comprise a metal organic framework prepared according to one or more methods disclosed herein.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIGS. 1A, 1B, 1C, 1D, 1E, and 1F show powder S-ray diffraction (PXRD) analysis graphs of metal organic frameworks respectively prepared according to Examples 1 to 6 of the present disclosure.

FIGS. 2A, 2B, 2C, 2D, 2E, and 2F show Fourier Transform Infrared Spectroscopy (FTIR) analysis graphs of metal organic frameworks respectively prepared according to Examples 1 to 6 of the present disclosure.

### DETAILED DESCRIPTION

Terms or words used in this specification and claims should not be interpreted as limited to their usual or dictionary meanings, and should be interpreted as meanings and concepts that comply with the technical ideas of the present disclosure based on the principle that the inventor may appropriately define the concept of the term in order to explain his or her own invention in the best way.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

### Method for Preparing Metal Organic Framework

The present disclosure provides a method for preparing a metal organic framework, the method comprising: (S1) preparing a precursor solution including a metal precursor and an organic ligand; (S2) emitting ultrasonic wave(s) to the precursor solution; (S3) centrifuging the precursor solution to remove a supernatant therefrom to obtain a precipitate; and (S4) washing and drying the precipitate, wherein a solvent of the precursor solution has a boiling point of 170° C. or lower.

The present disclosure provides a novel method for preparing a metal organic framework using acoustic cavitation caused by ultrasonic waves. The method reaction can be performed under relatively mild conditions, the metal organic framework can be synthesized even with low-power ultrasonic equipment, and the metal organic framework having the same structure as that as obtained by the conventional synthesis method can be prepared without use of the modulator.

Hereinafter, a method for preparing a metal organic framework of the present disclosure will be described in more detail.

### Precursor Solution Preparation (S1)

In the method for preparing a metal organic framework of the present disclosure, a precursor solution including a metal precursor and an organic ligand may be used.

The metal precursor included in the precursor solution may be used for providing metal ions constituting the framework of the metal organic framework. The specific type of the metal precursor may vary depending on the type of the metal organic framework to be synthesized. For example, the metal precursor may be/comprise at least one selected from the group consisting of Zn(CH₃COO)₂·2H₂O, Zn(NO₃)₂·6H₂O, and ZnCl₂.

The organic ligand may be used for performing a connection between metal ions. A specific kind of the organic ligand may vary depending on the kind of the desired metal organic framework being synthesized. For example, the organic ligand may be/comprise at least one selected from the group consisting of H₂BDC (terephthalic acid), H₂DOBDC (2,5-dihydroxyterephthalte), H₄DOBDC (2,5-Dihydroxyterephthalic acid), HATTFTB (tetrathiafulvalene-tetrabenzoate), MeIM (2-Methylimidazole), H₂BTDD (1H,7H-[1,4]Dioxino[2,3-F:5,6-F′]Bisbenzotriazole), and H₆HHTP (hexahydroxytriphenylene).

The precursor solution may include a solvent. The solvent may be configured to evenly disperse the metal precursor and the organic ligand therein. The condition under which the binding and reaction between the metal ion and the organic ligand are performed may vary depending on the type of the solvent. In accordance with the present disclosure, a solvent having a boiling point of 170° C. or lower, 160° C. or lower, or 155° C. or lower is used.

The solvent may be/comprise at least one selected from the group consisting of water, dimethylformamide, methanol, and ethanol. If the solvents listed above are used, the concentration of the ligand in the precursor solution may be increased (e.g., relative to some other solvents) which may reduce the amount of solvent used. The reaction time may be reduced even under a mild reaction condition (e.g., mild/room temperature, atmospheric pressure, etc.), thereby efficiently preparing the metal organic framework.

A molar ratio between the metal precursor and the organic ligand in the precursor solution may be in a range of 0.5:1 to 30:1, (e.g., 0.7:1 to 25:1). The molar ratio between the metal precursor and the organic ligand in the precursor solution may be determined/selected based on a ratio of the metal ion and the organic ligand in a desired organic metal structure. The molar ratio between the metal precursor and the organic ligand in the precursor solution may be adjusted/determined/selected based on a type of the metal organic framework to be synthesized. If the ratio between the metal precursor and the organic ligand is not appropriate, metal precursors and/or organic ligands may be unnecessarily wasted, thereby deteriorating the economic efficiency of the synthesis process.

The concentration of the organic ligand in the precursor solution may be 0.02M or greater and/or 0.3M or smaller, such as 0.02M or greater or 0.025M or greater and 0.3M or smaller or 0.25M or smaller. In the precursor solution of the present disclosure, the concentration of the organic ligand in the solution may be increased to a certain level or greater by using the solvent as described above. The amount of solvent used may be reduced (e.g., relative to other solvents). If a large amount of the solvent is required (e.g., due to other solvents or different solvent properties of the other solvent being used than those of the present disclosure), the concentration of the organic ligands in the precursor solution may be lower than that in the present disclosure.

In an example, the precursor solution may not include a modulator. By the method for preparing a metal organic framework of the present disclosure not including/requiring use of a modulator, the metal organic framework can be synthesized more economically and efficiently.

### Ultrasonic Emission (S2)

An acoustic cavitation phenomenon may be induced by emitting (e.g., sonicating) ultrasonic waves to the obtained precursor solution. Energy emitted in the process in which microbubbles generated via the acoustic cavitation phenomenon grow and collapse may be used/function as energy for nucleation and/or growth of the metal organic framework, thereby causing synthesis of the metal organic framework.

The emission time of the ultrasonic waves may be 4 hours or less (e.g., in a range of about 1 minute to about 4 hours). The ultrasonic wave emission time may vary depending on the type of the desired metal organic framework. For example, the ultrasonic wave emission time may be 1 hour or less, 30 minutes or less, 20 minutes or less, 15 minutes or less, or 10 minutes or less. The ultrasonic wave emission time may be 1 minute or greater, or 2 minutes or greater in the case of the synthesis of the metal organic framework such as MOF-5 (metal organic framework-5; Zn₄O(BDC)₃), ZIF-8 (zeolitic imidazolate framework-8), MOF-74 (metal organic framework-74; M₂(dobdc) (H₄dobdc=2,5-dihydroxyterephthalic acid; M=Mg, Co, Ni, Zn, Mn, Fe)), and Zn-HTTP (Zn-hexahydroxytriphenylene). Also, or alternatively, in the case of the synthesis of the metal organic framework such as MFU-41 (“Metal-Organic Framework Ulm University”-4l(arge); or Zn₂(TTFTB) (Zn₂-tetrathiafulvalene tetrabenzoate), the ultrasonic wave emission time may be 3 hours and 30 minutes or less, 3 hours or less, and/or 1 hour or greater, or 1 hour and 30 minutes or greater.

The ultrasonic waves may be emitted under a temperature condition of 50° C. or lower (e.g., in a range of 15° C. to 50° C.), such as 40° C. or lower, 35° C. or lower, or 30° C. or lower. The ultrasonic waves may be emitted under a temperature condition of 0° C. or higher, 5° C. or higher, 10° C. or higher, or 15° C. or higher. Unlike the solvothermal synthesis method, the presently disclosed method does not require high temperature conditions. Ultrasonic wave synthesis of metal organic framework has an advantage that the synthesis of the metal organic framework is possible at room temperature. In one example, the temperature condition may be based on a time at which the ultrasonic wave emission is started. For example, as energy is generated during the ultrasonic wave emission process, the temperature of the precursor solution may increase.

The ultrasonic wave emission may be performed using an sonication bath. The sonication bath may uniformly emit ultrasonic waves with a relatively low output (e.g., relative to a horn type sonicator used in some conventional ultrasonic synthesis methods). The horn type sonicator may be utilized if high energy concentration is for a small amount of sample. The sonication bath may be capable of emitting ultrasonic waves to a large amount of an sample with a relatively low energy density.

The ultrasonic wave emission may be performed under/in an air atmosphere and/or a nitrogen atmosphere. In the case of synthesis of a metal organic framework such as MFU-41, since the synthesis of the metal organic framework may not be smooth if performed with exposure to moisture, the synthesis should be performed under a nitrogen atmosphere. In other cases, where there is no or insignificant effect due to the moisture exposure, the synthesis of the metal organic framework may be performed under air atmosphere.

In one example, an intermediate structure of the metal organic framework may be formed via/by the ultrasonic wave emission. The intermediate structure formed in the present process may be changed into a final structure by/via a solvent exchange reaction with the solvent used in a subsequent washing process. For example, a dense intermediate structure may be formed by/via the ultrasonic wave emission, and an energy penalty may exist to convert the dense intermediate structure to a porous metal organic framework. Thus, such an energy penalty may be overcome by/via the exchange reaction with the solvent.

### Separation, Washing and Drying (S3 and S4)

A mixture comprising the metal organic framework and/or an intermediate structure of the metal organic framework may be obtained/formed by/via the above process, for example. The metal organic framework may be separated from the mixture, washed, and dried to finally obtain the metal organic framework.

The separation may be performed by/via centrifugation. If the obtained mixture is centrifuged, the metal organic framework may be in a precipitate. The supernatant may be removed therefrom, and the metal organic framework may be obtained from the precipitate remaining after the supernatant has been removed.

In one example, components and/or impurities that have not yet reacted may remain in the precipitate. Washing and drying the precipitate may be performed. The washing may be performed using one or more solvents. For example, the one or more solvents may be selected from the group consisting of DMF (dimethylformamide), chloroform, methanol, ethanol, DCM (dichloromethane), and acetone. The washing process may be performed by dispersing the precipitate in the washing solvent and performing centrifugation. For example, the intermediate structure of the metal organic framework may be formed through the ultrasonic wave emission step, and the intermediate structure may be changed to the final structure by/via subsequent washing(s).

Hereinafter, the present disclosure will be described in more detail with reference to Examples. The following Examples are intended for illustrating the present disclosure, and the scope of the present disclosure is not limited thereto.

### Example 1

Zn(CH₃COO)₂·2H₂O 1.642 g (7.5 mmol), H₂BDC 250 mg (1.5 mmol) and DMF 30 mL were mixed with each other in a conical tube to prepare a precursor solution.

Ultrasonic waves were emitted to the precursor solution for 2 minutes using the sonication bath. The resultant was centrifuged, and the supernatant was removed to obtain the precipitate (e.g., pellet). The obtained precipitate was washed with DMF (30 mL×twice) and CHCl₃ (20 mL×three times) and filtered, and dried under vacuum to prepare a first example metal organic framework.

### Example 2

Zn(CH₃COO)₂·2H₂O 247 mg (1.12 mmol), H₂DOBDC 50 mg (0.2 mmol) and DMF 3 mL were mixed with each other in a conical tube to prepare a precursor solution.

Ultrasonic waves were emitted to the precursor solution for 2 minutes using a sonication bath. 3 mL of methanol was added, and the resultant product was centrifuged. The supernatant was removed, and the obtained precipitate (e.g., pellet) was washed with methanol (5 mL×twice) and filtered, and dried under vacuum to prepare a second example metal organic framework.

### Example 3

Zn(NO₃)₂·6H₂O 1.188 g (4.0 mmol) was mixed with 3.6 mL of a solvent water and ethanol mixed at a molar ratio of 1:1 to prepare a first solution. H₄TTFTB 180 mg (0.263 mmol) was mixed with 3.6 mL of a solvent of DMF and ethanol mixed at a molar ratio of 3:1 to prepare a second solution. The first solution and the second solution were mixed with each other in a conical tube to prepare a precursor solution.

Ultrasonic waves were emitted to the precursor solution for 180 minutes using a sonication bath. Then the temperature, which was raised during the reaction process, was cooled to room temperature. The resultant product was centrifuged, and the supernatant was removed to obtain a precipitate (e.g., pellet). The obtained precipitate was washed with DMF (5 mL) and ethanol (5 mL), filtered, and dried under vacuum to prepare a third example metal organic framework.

### Example 4

Zn(CH₃COO)₂·2H₂O 917 mg (4.2 mmol), MeIM 417 mg (5 mmol) and DMF 20 mL were mixed with each other in a conical tube to prepare a precursor solution.

Ultrasonic waves were emitted to the precursor solution for 10 minutes using an sonication bath. The resultant was centrifuged, the supernatant was removed to obtain a precipitate (e.g., pellet, gel, paste, etc.). The precipitate was washed with methanol (10 mL×twice) and filtered, and dried under vacuum to prepare a fourth example metal organic framework.

### Example 5

A precursor solution was prepared by mixing anhydrous ZnCl₂ 384.8 mg (2.8 mmol), H₂BTDD 31.2 mg (0.12 mml), and anhydrous DMF 2 mL with each other in a conical tube in a nitrogen-filled glove box.

Ultrasonic waves were emitted to the precursor solution for 90 minutes using an sonication bath. The resultant was centrifuged, and the supernatant was removed to obtain a precipitate (e.g., pellet). The obtained precipitate was washed with DMF (10 mL×twice) and DCM (10 mL×twice) and filtered, and dried under vacuum to prepare a fifth metal organic framework.

### Example 6

Zn(CH₃COO)₂·2H₂O 385.5 mg (1.8 mmol), H₆HHTP 63.5 mg (0.12 mml) and 2 mL of deionized water were mixed with each other in a conical tube to prepare a precursor solution.

Ultrasonic waves were emitted to the precursor solution for 2 minutes using an sonication bath. The resultant was centrifuged, and the supernatant was removed to obtain a precipitate (e.g., pellet). The obtained precipitate was washed with methanol (5 mL) and acetone (5 mL) and filtered, and then re-dispersed in 2 mL of water and then was centrifuged and washed with acetone (5 mL). This washing process was repeated three times, followed by drying under vacuum to prepare a sixth metal organic framework.

### Example 7

A precursor solution was prepared by mixing Zn(CH₃COO)₂·2H₂O 9.17 g (41.8 mmol), MeIM 4.17 g (50 mml) and DMF 200 mL with each other in a bottle.

Ultrasonic waves were emitted to the precursor solution for 10 minutes using an sonication bath. The resultant was centrifuged and the supernatant was removed to obtain a precipitate (e.g., pellet). The obtained precipitate was washed with methanol (100 mL×twice) and filtered, and dried under vacuum to prepare a seventh metal organic framework.

### Example 8

A precursor solution was prepared by mixing an anhydrous ZnCl₂ 7.696 g (28 mmol), H₂BTDD 622 mg (1.2 mml), and an anhydrous DMF 40 mL with each other in a bottle in a nitrogen-filled glove box.

Ultrasonic waves were emitted to the precursor solution for 90 minutes using an sonication bath. The resultant was centrifuged, and the supernatant was removed to obtain a precipitate (e.g., pellet). The obtained precipitate was washed with DMF (40 mL×twice) and DCM (40 mL×twice) and filtered, and dried under vacuum to prepare an eighth metal organic framework.

### Example 9

A precursor solution was prepared by mixing Zn(CH₃COO)₂·2H₂O 16.42 g (75 mmol), H₂BDC 2.5 g (15 mmol) and DMF 300 mL with each other in a bottle.

Ultrasonic waves were emitted to the precursor solution for 2 minutes using an sonication bath. The resultant was centrifuged, and the supernatant was removed to obtain a precipitate (e.g., pellet). The obtained precipitate was washed with DMF (300 mL×twice) and CHCl₃ (200 mL×three times) and filtered, and dried under vacuum to prepare a ninth metal organic framework.

### Example 10

A precursor solution was prepared by mixing Zn(CH₃COO)₂·2H₂O 24.7 g (112 mmol), H₂DOBDC 5 g (25 mml) and DMF 300 mL with each other in a bottle.

Ultrasonic waves were emitted to the precursor solution for 2 minutes using an sonication bath. The resultant was centrifuged and the supernatant was removed to obtain a precipitate (e.g., pellet). The obtained precipitate was washed with methanol (500 mL×twice) and filtered, and dried under vacuum to prepare a tenth metal organic framework.

The synthesis conditions used in the above Examples are summarized in Table 1 below. The ligand-based yield as described in Table 1 below may be calculated based on the weight of the finally obtained metal organic framework and a formula weight of each metal organic framework. For example, the weight of the metal organic framework that can be produced if all of the ligand is involved in the synthesis of the metal organic framework corresponds to 100% yield, and the yield is calculated as a ratio of a weight of the actually obtained metal organic framework to the weight corresponding to the 100% yield.

TABLE 1

| | | | | | | Ligand- |
|---|---|---|---|---|---|---|
| | | Synthesis | Synthesis | | Organic ligand | based |
| | Metal organic | temperature | time | Synthesis | concentration | yield |
| | framework | (° C.) | (min) | solvent type | (M) | (%) |
| Example 1 | MOF-5 | RT | 2 | DMF | 0.05 | 76 |
| Example 2 | MOF-74 | RT | 2 | DMF + MeOH | 0.042 | 86 |
| Example 3 | Zn₂(TTFTB) | RT (Final | 180 | DMF + EtOH + | 0.036 | 12 |
| | | temperature | | water | | |
| | | 75° C.) | | | | |
| Example 4 | ZIF-8 | RT | 10 | DMF | 0.25 | 54 |
| Example 5 | MFU-4l | RT(Final | 90 | DMF(N₂) | 0.06 | 44 |
| | | temperature | | | | |
| | | 60° C.) | | | | |
| Example 6 | Zn-HHTP | RT | 2 | Water | 0.06 | 67 |
| Example 7 | ZIF-8 | RT | 10 | DMF | 0.25 | 87 |
| Example 8 | MFU-4l | RT | 90 | DMF(N₂) | 0.06 | 48 |
| Example 9 | MOF-5 | RT | 2 | DMF | 0.05 | 93 |
| Example 10 | MOF-74 | RT | 2 | DMF | 0.042 | 95 |

### Experimental Example 1. Measurement of Specific Surface Area of Metal Organic Framework

Brunauer-Emmett-Teller (BET) specific surface areas of the metal organic frameworks of Examples 1 to 6 were measured and compared with literature values and theoretical values. The specific surface area measurement was performed using N₂ adsorption-desorption isotherm, and Micromeritics ASAP 2020 Surface Area and Porosity Analyzer equipment was used. N₂ adsorption isotherm was measured at 77K using ultra-high purity grade N₂, and each measurement sample was activated under vacuum conditions at 4 μmHg. The measurement results are summarized in Table 2 below, and the specific surface area unit in Table 2 below is m²/g.

TABLE 2

| | | Specific | Specific | Specific |
|---|---|---|---|---|
| | Metal | surface area | surface area | surface area |
| | organic | measurement | literature | theoretical |
| | framework | value | value | value |
| Example 1 | MOF-5 | 3370 | 3800(a)/ | 3534.2 |
| | | | 3208(b) | |
| Example 2 | MOF-74 | 796 | 800-1100 | 985 |
| Example 3 | Zn₂(TTFTB) | 540 | 662 | 533.5 |
| Example 4 | ZIF-8 | 1790 | 1497(a)/ | 1327.7 |
| | | | 1500-2000(b) | |
| Example 5 | MFU-4l | 3150 | 3525 | 3185.7 |
| Example 6 | Zn-HHTP | 258 | 329.1 | 923.0 |
| Example 7 | ZIF-8 | 1540 | 1497(a)/ | 1327.7 |
| | | | 1500-2000(b) | |
| Example 8 | MFU-4l | 2760 | 3525 | 3185.7 |
| Example 9 | MOF-5 | 2990 | 3800(a)/ | 3534.2 |
| | | | 3208(b) | |
| Example 10 | MOF-74 | 726 | 800-1100 | 985 |

In Table 2, among the specific surface area literature values in MOF-5 and ZIF-8 are values indicated (a) and (b). (a) refers to the specific surface area values of a metal organic framework synthesized using the conventional solvothermal synthesis method, and (b) refers to the specific surface area values of a metal organic framework synthesized using ultrasonic waves.

As may be identified from the results of Table 2 above, each of the organic metal frameworks synthesized in an example of the present disclosure exhibits a measured specific surface area value consistent with a published specific surface area value of the same metal organic framework having the same structure, and consistent with a theoretical value. As such, the metal organic frameworks preparing as disclosed herein results in a metal organic framework having a structure consistent with what would theoretically expected and consistent with that of the metal organic framework produced using other synthesis methods. For example, Examples 6 to 10, which were synthesized in relatively high mass amounts/scale, the specific surface area value was similar to corresponding published literature samples in which relatively small-amount synthesis was performed. As such, the preparation method of the present disclosure may be suitably applied to mass synthesis.

### Experimental Example 2. PXRD and FTIR Analysis of Metal Organic Frameworks

PXRD (Powder X-ray Diffraction) analysis was performed on the metal organic frameworks of Examples 1 to 6. Cu Kα radiation (λ=1.5406 Å) was used as an analysis facility, and Rigaku MiniFlex 600 equipped with Rigaku D/teX Ultra silicon strip detector was used. The voltage and current in the X-ray tubes were 40 kV and 15 mA, respectively, and samples subjected to PXRD analysis were prepared by placing the samples on zero-background silicon crystal plates. Diffraction data were collected in the range of 2θ=3° to 60°, and Le Bail refinement was performed using GSAS-II while Chebyshev-1 was used as a background function.

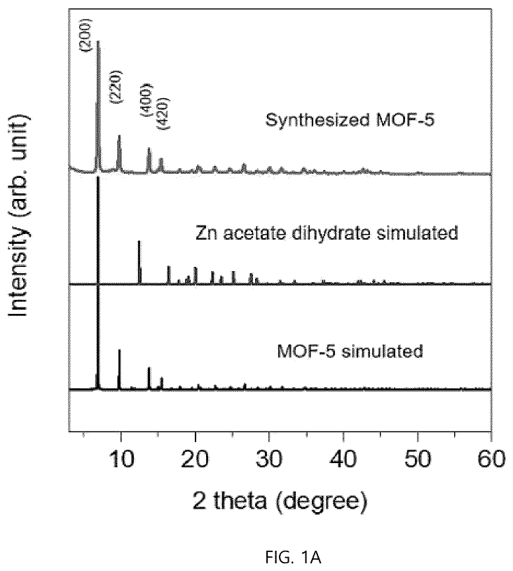

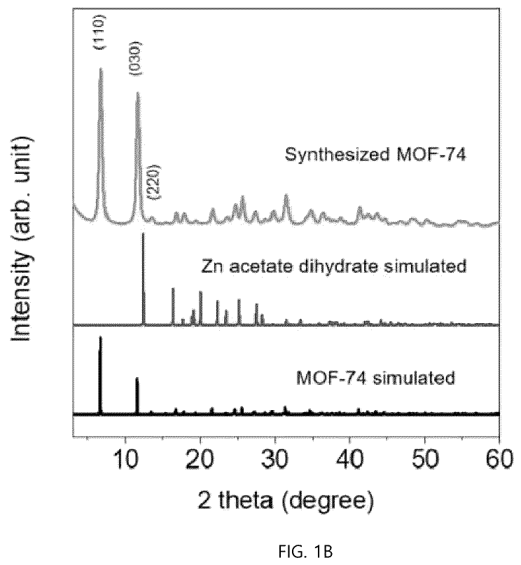

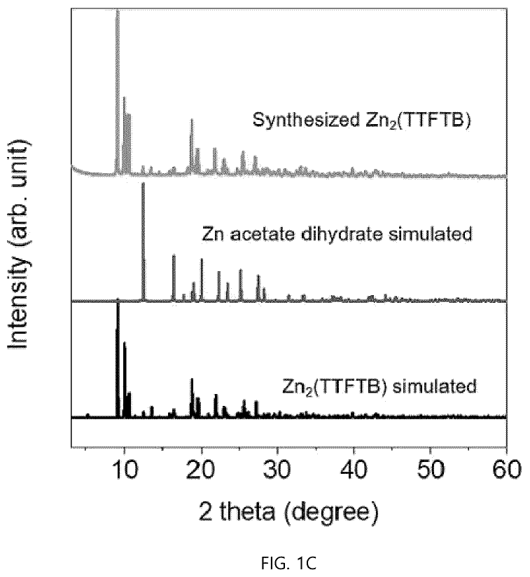

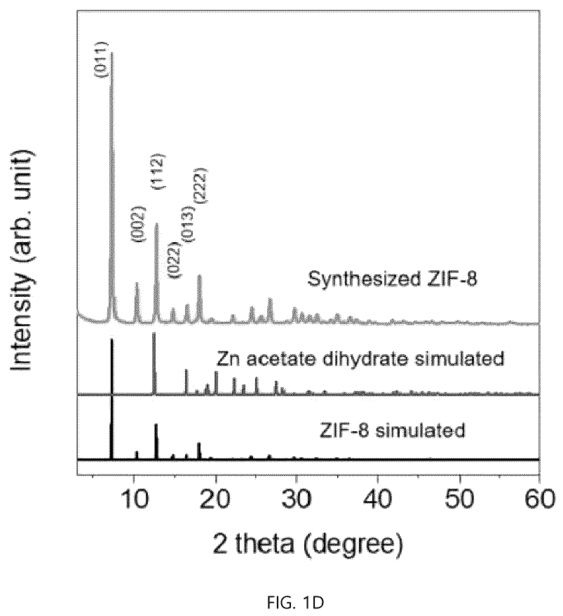

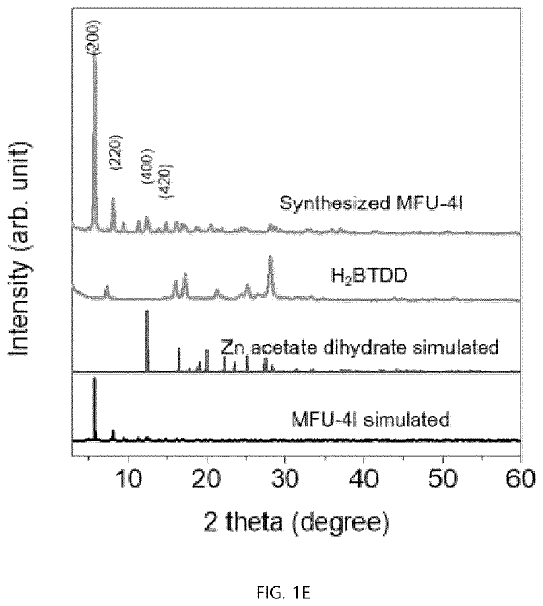

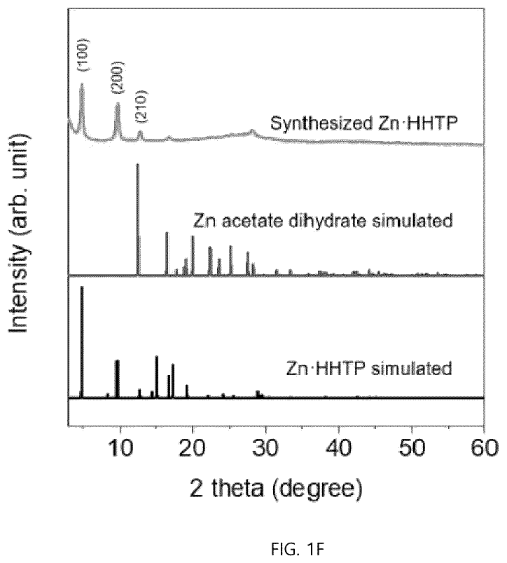

The PXRD analysis results of Examples 1 to 6 are shown in FIGS. 1A to 1F. From the results of FIGS. 1A to 1F, it was identified that, in the example metal organic frameworks prepared via the preparation method of the present disclosure, metal ions and organic ligands were structurally well bonded to each other. Further, structures of the example metal organic framework synthesized as disclosed herein were consistent with corresponding structures of metal organic frameworks obtained with a single crystal structure. Impurities in the metal organic framework are present, fitting may result in a goodness of fit (GoF) value (e.g., in the reliability factor value of XRD Le Bail fitting) is not close to 1. The crystal structure analysis indicated that the final structure of the example metal organic frameworks prepared as disclosed herein exhibited only the structure of an individual metal organic framework with having any impurities (for example, metal precursor, organic ligand, formation of metal oxide due to side reaction, etc.).

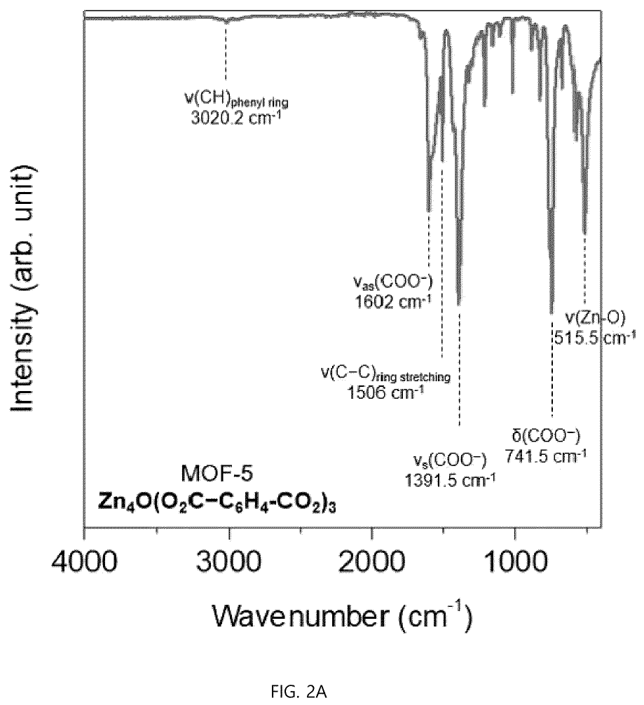

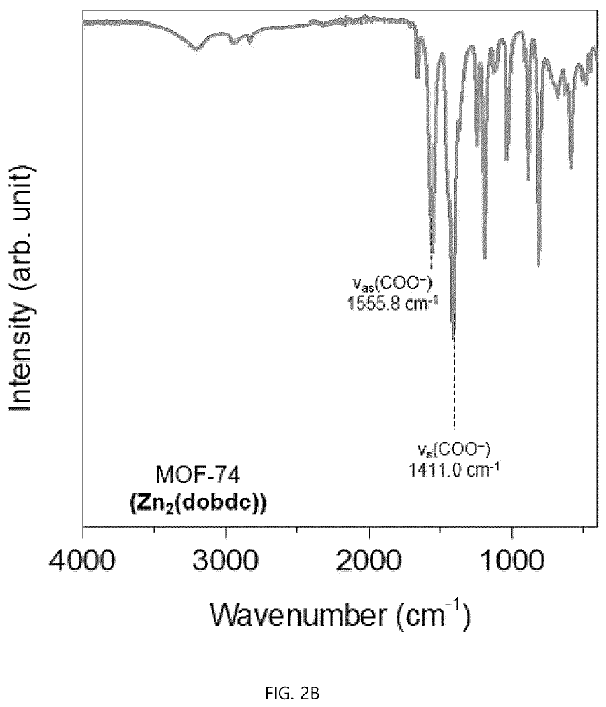

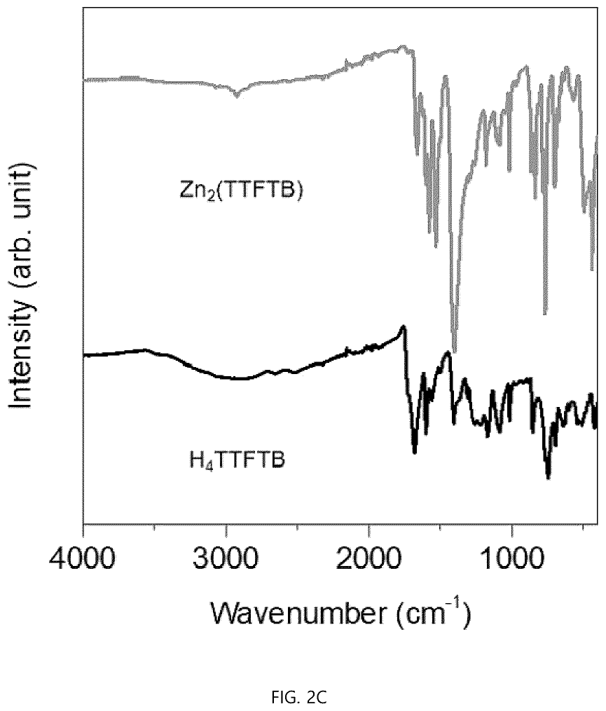

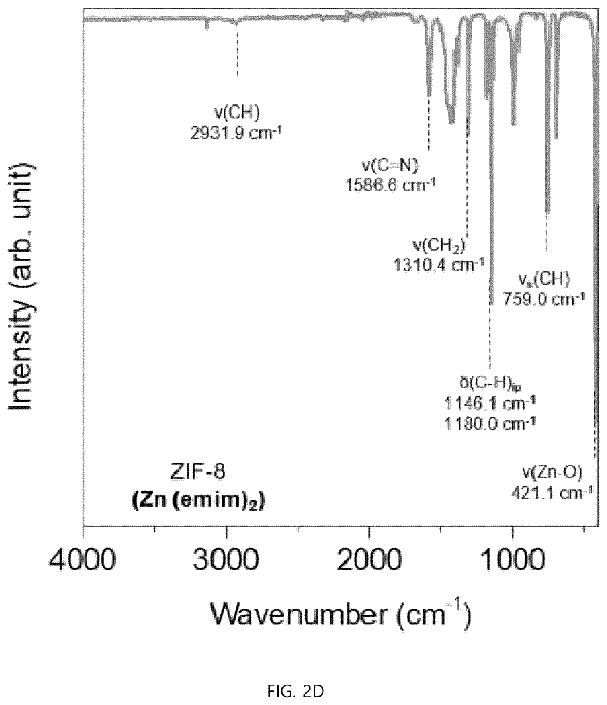

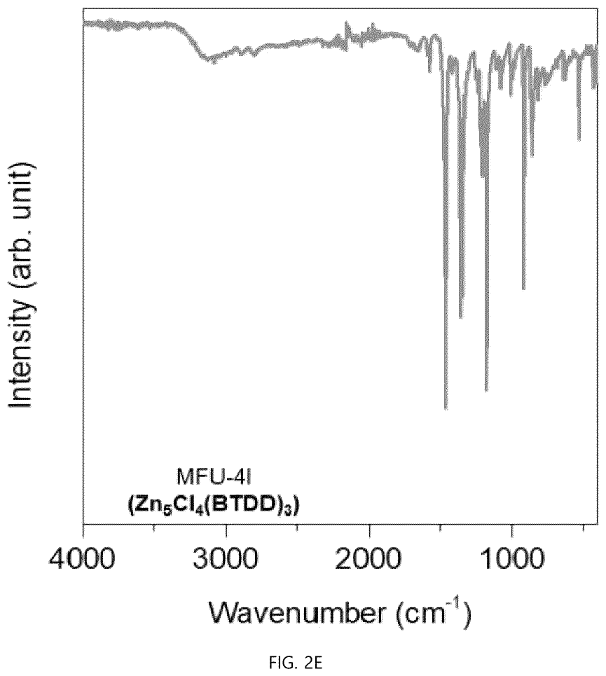

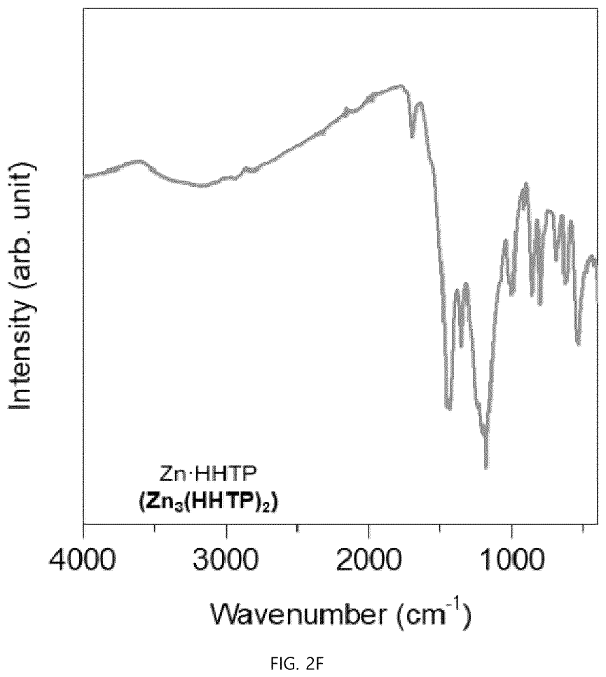

FIGS. 2A to 2F show the results of FTIR (Fourier Transform Induced Spectroscopy) analysis performed on the example metal organic frameworks of Examples 1 to 6. Bruker single reflection ALPHA-Platinum ATR spectrometer equipped with diamond crystal accessories was used as an analysis facility, and the measurement was performed in the range of 4000 to 400 cm⁻¹ at a resolution of 2 cm⁻¹.

The FTIR analysis results indicate that all of the characteristic functional groups expressed via coordination bonds between the metal and the organic ligand in the metal organic framework are expressed in the same manner as in corresponding metal organic frame works synthesized by the solvothermal synthesis method. Metal precursors, and organic ligands that did not participate in synthesis, and a vibration mode expressed in metal oxides due to side reactions were not observed. These results further support the pure metal organic framework crystal was demonstrated from a binding point of view.

For example, in the case of the synthesized MOF-5, the absorption band at 515.5 cm⁻¹ was found to be due to the Zn—O vibration of the Zn₄O coordinated as the tetrahedron. In the case of MOF-74, based on two characteristic absorption peaks of 1555.8 cm⁻¹ and 1411.9 cm⁻¹, corresponding to the asymmetric and symmetrical vibrations of the coordinated carboxylate, respectively, the expression of the SBU (Secondary building unit) structure of MOF-74 was identified. Thus, the synthesis of MOF-74 was demonstrated. Regarding ZIF-8, tetrahedral SBU composed of Zn²⁺ and imidazolate which acts as a bridge was identified based on the absence of the band near 3000 cm⁻¹ and 2650 cm⁻¹ associated with NH—N hydrogen bonds in the FTIR spectrum of ZIF-8. MFU-41 did not exhibit N—H stretching vibration of about 3200 cm⁻¹ in the FTIR spectrum thereof, thus confirming that the H₂BTDD ligand was included in the framework in a deprotonated form. In the FTIR spectrum of Zn-HHTP, an attenuated O—H stretchable band of about 3100 cm⁻¹ represents a hydroxy group coordinated in the deprotonated form of the ligand, thus demonstrating Zn-HHTP composed of a deprotonated ligand bound to Zn under this observation.

The present disclosure has been made to solve the above-mentioned problems occurring in the prior art while advantages achieved by the prior art are maintained intact.

An aspect of the present disclosure provides a method for preparing a metal organic framework capable of solving the above problems.

More specifically, the present disclosure provides a method for preparing a metal organic framework, wherein the method is suitable for synthesizing the metal organic framework in a large quantity under a mild condition.

The technical problems to be solved by the present disclosure are not limited to the aforementioned problems, and any other technical problems not mentioned herein will be clearly understood from the following description by those skilled in the art to which the present disclosure pertains.

In order to achieve the purpose, the present disclosure provides a method for preparing a metal organic framework.

More specifically, (1) the present disclosure provides a method for preparing a metal organic framework, the method comprising: preparing a precursor solution including a metal precursor and an organic ligand; emitting an ultrasonic wave to the precursor solution; centrifuging the precursor solution to remove a supernatant therefrom to obtain a solid/precipitate; and washing and drying the solid/precipitate, wherein a solvent of the precursor solution has a boiling point of 170° C. or lower.

(2) The present disclosure provides the method for preparing the metal organic framework of the (1), wherein the metal precursor is at least one selected from the group consisting of Zn(CH₃COO)₂·2H₂O, Zn(NO₃)₂·6H₂O, and ZnCl₂.

(3) The present disclosure provides the method for preparing the metal organic framework of the (1) or (2), wherein the organic ligand is at least one selected from the group consisting of H₂BDC, H₂DOBDC, HADOBDC, H₄TTFTB, MeIM, H₂BTDD, and H₆HHTP.

(4) The present disclosure provides the method for preparing the metal organic framework of one of the (1) to (3), wherein the solvent of the precursor solution is at least one selected from the group consisting of water, dimethylformamide, methanol, and ethanol.

(5) The present disclosure provides the method for preparing the metal organic framework of one of the (1) to (4), wherein a molar ratio between the metal precursor and the organic ligand is in a range of 0.5:1 to 30:1.

(6) The present disclosure provides the method for preparing the metal organic framework of one of the (1) to (5), wherein a concentration of the organic ligand in the precursor solution is in a range of 0.02M or greater and 0.3M or smaller.

(7) The present disclosure provides the method for preparing the metal organic framework of one of the (1) to (6), wherein the precursor solution is free of a modulator.

(8) The present disclosure provides the method for preparing the metal organic framework of one of the (1) to (7), wherein the ultrasonic wave is emitted for a time duration of 4 hours or smaller.

(9) The present disclosure provides the method for preparing the metal organic framework of one of the (1) to (8), wherein the ultrasonic wave is emitted under a temperature condition of 50° C. or lower.

(10) The present disclosure provides the method for preparing the metal organic framework of one of the (1) to (9), wherein the ultrasonic wave emission is performed using a sonication bath.

(11) The present disclosure provides the method for preparing the metal organic framework of one of the (1) to (10), wherein the ultrasonic wave emission is performed under an air atmosphere or a nitrogen atmosphere.

(12) The present disclosure provides the method for preparing the metal organic framework of one of the (1) to (11), wherein a solvent used for the washing is at least one selected from the group consisting of DMF, chloroform, methanol, ethanol, DCM, and acetone.

The method for preparing a metal organic framework of the present disclosure can efficiently synthesize a metal organic framework within a short time under relatively mild conditions compared to a conventional method for synthesizing a metal organic framework, and particularly, may be suitable for mass synthesis of a metal organic framework.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for preparing a metal organic framework, the method comprising:
preparing a precursor solution comprising a metal precursor and an organic ligand;
emitting an ultrasonic wave to the precursor solution;
centrifuging the precursor solution;
removing a supernatant from the centrifuged precursor solution to obtain a precipitate; and
washing and drying the precipitate, wherein a solvent of the precursor solution has a boiling point in a range of 35° C. to 170° C.

2. The method of claim 1, wherein the metal precursor comprises at least one selected from the group consisting of:
Zn(CH₃COO)₂·2H₂O,
Zn(NO₃)₂·6H₂O, and
ZnCl₂.

3. The method of claim 1, wherein the organic ligand comprises at least one selected from the group consisting of:
H₂BDC,
H₄DOBDC,
H₄TTFTB,
MeIM,
H₂BTDD, and
H₆HHTP.

4. The method of claim 1, wherein the solvent of the precursor solution comprises at least one selected from the group consisting of:
water,
dimethylformamide,
methanol, and
ethanol.

5. The method of claim 1, wherein a molar ratio between the metal precursor and the organic ligand is in a range of 0.5:1 to 30:1.

6. The method of claim 1, wherein a concentration of the organic ligand in the precursor solution is in a range of 0.02M to 0.3M.

7. The method of claim 1, wherein the precursor solution does not comprise a modulator.

8. The method of claim 1, wherein the emitting ultrasonic wave is performed for a time duration in a range of 1 minute to 4 hours.

9. The method of claim 1, wherein the emitting the ultrasonic wave is performed under a temperature in a range of 15° C. to 50° C.

10. The method of claim 1, wherein the emitting the ultrasonic wave is performed using a sonication bath.

11. The method of claim 1, wherein the emitting the ultrasonic wave is performed in air atmosphere or in nitrogen atmosphere.

12. The method of claim 1, wherein a solvent used for the washing comprises at least one selected from the group consisting of:
DMF,
chloroform,
methanol,
ethanol,
DCM, and
acetone.

13. A method for preparing a metal organic framework, the method comprising:
preparing a precursor solution comprising:
a metal precursor,
an organic ligand; and
a solvent;
emitting, via a sonication bath, an ultrasonic wave to the precursor solution;
centrifuging the precursor solution;
removing a supernatant from the centrifuged precursor solution to obtain a precipitate; and
washing and drying the precipitate.

14. The method of claim 13, wherein the solvent has a boiling point in a range of 35° C. to 170° C.

15. The method of claim 13, wherein the solvent comprises at least one solvent selected from the group consisting of water, dimethylformamide, methanol, and ethanol.

16. A method for preparing a metal organic framework, the method comprising:
preparing a precursor solution comprising:
a metal precursor,
an organic ligand; and
a solvent selected from a group consisting of water, dimethylformamide, methanol, and ethanol;
emitting, via a sonication bath, an ultrasonic wave to the precursor solution;
centrifuging the precursor solution; and
removing a supernatant from the centrifuged precursor solution to obtain a precipitate.

17. The method of claim 16, wherein the solvent has a boiling point in a range of 35° C. to 170° C.

18. The method of claim 17, wherein the metal precursor comprises at least one selected from the group consisting of:
Zn(CH₃COO)₂·2H₂O,
Zn(NO₃)₂·6H₂O, and
ZnCl₂.

19. The method of claim 18, wherein the organic ligand comprises at least one selected from the group consisting of:
H₂BDC,
H₄DOBDC,
H₄TTFTB,
MeIM,
H₂BTDD, and
H₆HHTP.

20. The method of claim 16, wherein a solvent used for washing the precipitate comprises at least one selected from the group consisting of:
DMF,
chloroform,
methanol,
ethanol,
DCM, and
acetone.
